(19) United States
(12) Patent Application Publication
(10) Pub. No.: US 2013/0045388 A1
(43) Pub. Date: Feb. 21, 2013

(54) MATERIALS AND METHODS FOR MANUFACTURING POLYCULTURE EQUIPMENT

(71) Applicant: Jon Carl Thenhaus, Beaverton, OR (US)

(72) Inventor: Jon Carl Thenhaus, Beaverton, OR (US)

(21) Appl. No.: 13/210,869

(22) Filed: Aug. 16, 2011

(51) Int. Cl. B32B 27/34; B32B 21/08; C09D 175/02; B32B 17/10; B32B 27/08; E06B 5/00; B32B 15/088

(52) U.S. Cl. 428/423.1; 156/108; 428/474.4; 428/479.6; 428/458; 428/435; 428/476.3; 524/589

(57) ABSTRACT

A method of manufacturing polyculture equipment includes providing a building material to build the polyculture equipment; applying a waterproof coating of polyurea or polyaspartic to an interior surface of the building material; affixing an acrylic or glass window to an aperture in the building material; and applying polyurea or polyaspartic around edges of the window to provide a waterproof seal

### BACKGROUND OF THE INVENTION

The present invention generally relates to waterproof materials and more specifically to materials and methods for manufacturing polyculture equipment.

Currently, polyculture equipment (an integration of hydroponics, vermiculture and aquaculture) is constructed using molded plastic, ethylene propylene diene monomer (EPDM) liners, or fiberglass.

It would be desirable to manufacture waterproof polyculture equipment utilizing common building materials.

### SUMMARY OF THE INVENTION

In one aspect of the present invention, a method of manufacturing polyculture equipment includes providing a building material; and applying a coating of polyurea to a surface of the building material, thereby providing a waterproof seal for the polyculture equipment.

In another aspect of the present invention, a method of manufacturing polyculture equipment includes providing a building material to build the polyculture equipment; applying a waterproof coating of polyurea or polyaspartic to an interior surface of the building material; affixing an acrylic or glass window to an aperture in the building material; and applying polyurea or polyaspartic around edges of the window to provide a waterproof seal.

In yet another aspect of the present invention, a substance for polyculture equipment includes a building material and; a coating of polyurea or polyaspartic.

### BRIEF DESCRIPTION OF THE DRAWINGS

FIG. 1 depicts a perspective view of an embodiment of the present invention;

FIG. 2 depicts a perspective view of the layers of the embodiment of FIGS. 1; and

FIG. 3 depicts a perspective view of a partially-completed component of polyculture equipment according to the embodiment of FIG. 1.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a method of manufacturing polyculture equipment.

A device and method may utilize a waterproof coating that can be used on a variety of structural materials for custom shapes and sizes.

An embodiment of a device may include polyculture equipment, which may be constructed of building materials such as wood, metal, glass, acrylic, and/or plastic. The materials may then be coated with a polyurea and/or polyaspartic polyurea material to create a durable water-proof seal on the intended surfaces. Once coated, glass and/or acrylic windows may be affixed using silicone in place. The coating may then applied around the edges to bond the glass and/or acrylic in place.

In an embodiment, the polyurea and polyurea polyaspartic coatings may provide an increased durability to the construction of the equipment. The waterproof coating may also provide added rigidity and strength to the product, allowing for a multitude of substrates to be used. The coating may also allows adding of acrylic and/or glass viewing windows to the equipment, providing easy analysis of fish disease and/or behavior. The coating texture may provide increased surface area for bacteria necessary for the nitrification process.

In an embodiment, the polyculture system may be constructed of a specified building material. The building material (wood, metal, glass, plastic) is selected per consumer taste. The material may then be coated in a polyurea and/or polyaspartic polyurea coating to provide a durable waterproof coating to the equipment. Without this coating the equipment would not be waterproof. It also would not be durable enough to handle the substrate that is required for the system to operate. The coated surface may be used as a water-proof interior surface for the polyculture equipment, to retain water for hydroponics or fish, etc.

An embodiment may include a method that allows a person to construct polyculture equipment by waterproofing the necessary surface areas. The method of manufacturing is a specific way of waterproofing polyculture equipment. Many other applications are possible. The method may produce polyculture equipment to the preference of a consumer.

Currently polyculture equipment is constructed using molded plastic, EPDM liners, or fiberglass. An alternative may be used on a variety of structural materials for custom shapes and sizes, be used to construct viewing windows for fish analysis.

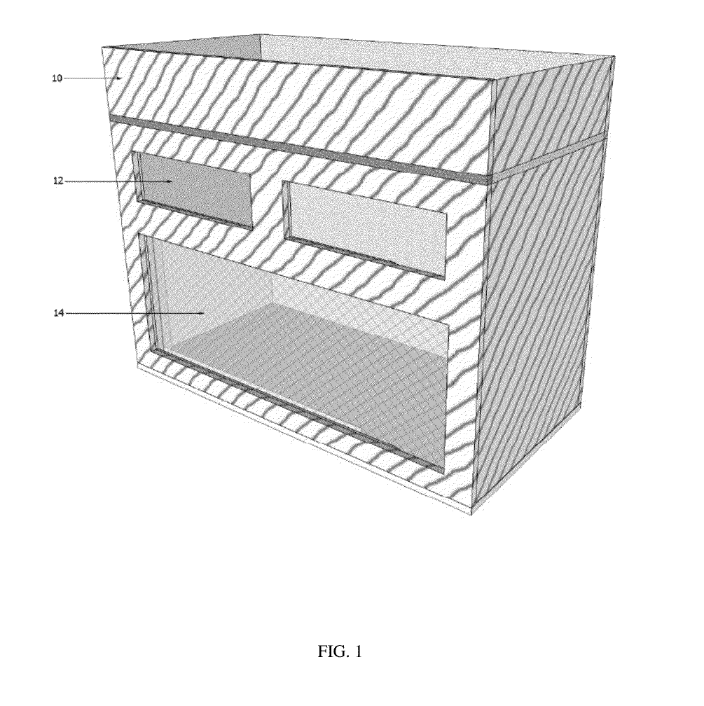

As depicted in FIG. 1, an embodiment of the present invention may include a building material 10, constructed according to preference and then prepared for coating. Once finished, a layer of polyurea 12 and/or polyaspartic urea may be applied providing the waterproof coating for the material. FIG. 1 depicts layer of polyurea 12, which would be applied to an interior surface of the building material 10, and would generally not be visible from a front view. The equipment may then be prepared for the addition of an acrylic or glass window 14.

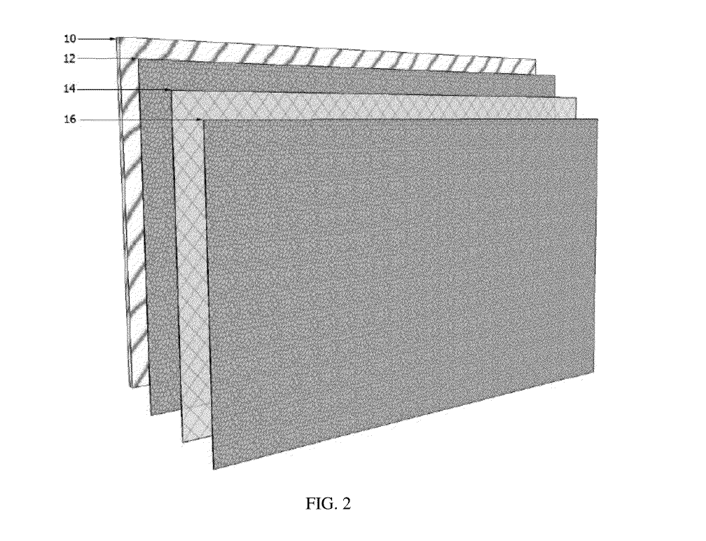

As depicted in FIG. 2, embodiments may have layers of material. Building material 10 may be outermost, which is coated with a layer of polyurea 12 so it will be waterproof. An acrylic or glass window 14 may be set in an aperture of the building material 10. Once the window is set in place, a secondary coating of polyurea 16 may be applied, bonding the window to the polyurea primary coating 12.

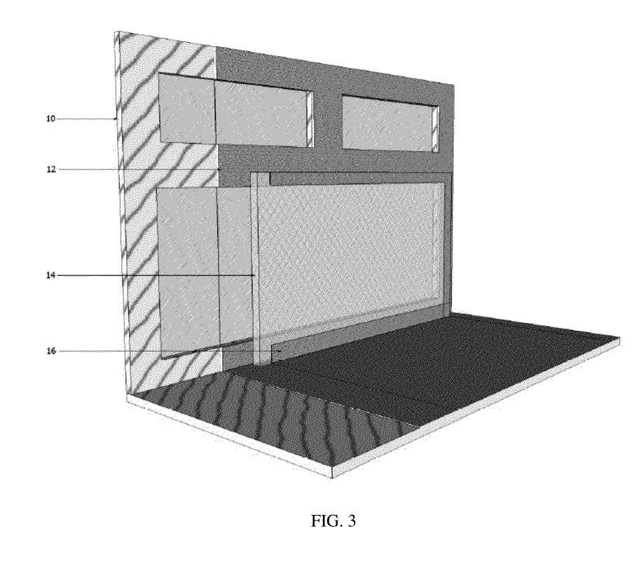

As depicted in FIG. 3, the secondary coating 16 may cover at least the edges of the window 14, to provide a waterproof seal. Window 16 may set flush with an aperture in the building material 10, or may be set behind an aperture in window 16.

Embodiments may include a substance for manufacturing polyculture equipment, comprising: a building material; a coating of polyurea or polyaspartic; an acrylic or glass window; and a secondary coating of polyurea or polyaspartic.

I claim:

1. A method of manufacturing polyculture equipment, comprising:
providing a building material; and
applying a coating of polyurea to a surface of the building material, thereby providing a waterproof seal for the polyculture equipment.

2. The method of claim 1, wherein the polyurea is a polyaspartic polyurea.

3. The method of claim 1, further comprising:
providing an acrylic or glass window;
affixing the window to an aperture in the building material; and
applying a second coating of polyurea around edges of the window, thereby providing a waterproof seal.

4. The method of claim 3, wherein the window is fixed in place using silicone.

5. The method of claim 3, wherein the second coating of polyurea, which is at the edges of the window, bond with the first coating of polyurea, which is on the building material, thereby providing a waterproof seal.

6. The method of claim 1, wherein the coating is applied to an interior surface of the building material, thereby providing a surface area for bacteria utilized in the polyculture equipment

7. The method of claim 1, wherein the building material is wood.

8. The method of claim 1, wherein the building material is metal.

9. The method of claim 1, wherein the building material is glass.

10. The method of claim 1, wherein the building material is acrylic

11. The method of claim 1, wherein the building material is plastic.

12. A method of manufacturing polyculture equipment, comprising:
providing a building material to build the polyculture equipment;
applying a waterproof coating of polyurea or polyaspartic to an interior surface of the building material;
affixing an acrylic or glass window to an aperture in the building material; and
applying polyurea or polyaspartic around edges of the window to provide a waterproof seal.

13. A substance for polyculture equipment, comprising:
a building material and;
a coating of polyurea or polyaspartic.

14. The substance of claim 13, further comprising:
an acrylic or glass window; and
a second coating of polyurea or polyaspartic polyurea to form a waterproof seal.
